(19) United States
(12) Patent Application Publication
(10) Pub. No.: US 2006/0176519 A1
(43) Pub. Date: Aug. 10, 2006

(54) Black out correction device

(75) Inventor: Hiroshi Ouchi, Hirakata-shi (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/349,902

(22) Filed: Feb. 9, 2006

(30) Foreign Application Priority Data
Feb. 10, 2005 (JP) 2005-033811

(51) Int. Cl. H04N 1/40

(52) U.S. Cl. 358/443

(57) ABSTRACT

A black out correction device according to the present invention comprises a correction level storage, a comparator and a selector. The correction level storage memorizes a signal level equal to an original signal level of a sampled signal outputted from an image sensing device when a black out is generated in a video created based on the sampled signal as a high-brightness clamping level. The comparator compares the signal level of sampled signal to a reference level for judging whether or not the black out is generated. The selector selects and outputs the high-brightness clamping level when a result of the comparison by the comparator shows that the signal level falls below the reference level, while selecting and outputting the sampled signal when the comparison result shows otherwise.

### BACKGROUND OF THE INVENTION

1. Field of the Invention

The present invention relates to a black out correction device installed in an image sensor.

2. Description of the Related Art

In recent years, as a camera to be installed in a mobile telephone is often employed a camera system in which an image sensor of the MOS type (Metal Oxide Semiconductor) is adopted. The MOS-type image sensor is characterized in its battery friendliness and therefore operable via a single power supply. Accordingly, the camera system provided with the MOS-type image sensor requires a smaller number of parts to be installed therein than a camera system provided with an image sensor of the CCD (Charge Coupled Device) type, and is thus the most suitable for the mobile telephone.

A configuration and an operation of the conventional MOS-type image sensor are described below. FIG. 6 shows a photodiode and an output circuit for a pixel. FIG. 7 shows waveforms of respective components and a timing chart in the case of an incident light of a low brightness.

Assuming that a reset pulse RS is applied to a gate of a reset transistor 63 during a time period t0-t1, and a read-out pulse TR is applied to a gate of a read-out transistor 62 at a time t3 in the conventional MOS-type image sensor, a time period t0-t3 is a non-signal period when a signal is not outputted to a node Sout. At the time t0 in the non-signal period, a transistor 65 is conducted by a pulse LG, a transistor 66 is conducted by a pulse SH, and a transistor 69 is conducted by a pulse CL. Further, in response to the conduction of the transistor 69, charges corresponding to a voltage VH are stored in a sampling capacitor 68, and the voltage VH is outputted to an output signal wire.

When the reset transistor 63 is conducted, a voltage of a gate node FD of an output transistor 64 is reset and initialized to a power-supply voltage VDD. At the time, a potential of the node Sout is VDD-V_{GS} provided that a voltage between a gate and a source of the transistor 65 is V_{GS} because the transistor 65 is conducted. When the reset transistor 63 is turned off at the time t1, charges corresponding to a voltage of the node Sout are stored in a clamping capacitor 67 and clamped therein.

The transistor 69 is turned off in response the rising of the pulse CL at the time t2, while the sampling capacitor 68 is clamped to the voltage VH, which constitutes a reference level of the output signal wire.

During a time period t3-t4, the read-out pulse TR is applied to the gate of the read-out transistor 62. Then, charges of the photodiode 61 are transferred to the gate node FD via the read-out transistor 62, and then converted into a voltage by means of a gate capacitance of the output transistor 64 and outputted to the node Sout. The voltage outputted to the node Sout then is read and sampled. The output voltage is read as a signal component Vₛ representing a decrement in comparison to the voltage VDD-V_{GS} clamped during the non-signal period, which is outputted to the output signal line as ΔV=Vₛ because the sampling capacitor 68 is clamped to the voltage VH at the time. The time period t3-t4 is a transfer period. The charges are retained in a period from the time t4 to a next rising timing of the reset pulse RS, when the charges are stored in the photodiode 61 in accordance with an incident light amount.

It has become evident that there is no longer any output when an intensive light enters into the MOS-type (CMOS-type, in particular) image sensor, which unfavorably generates such a phenomenon that a relevant part appears to be black (black out) as if there was not any incident light into the part at all.

### SUMMARY OF THE INVENTION

Therefore, a main object of the present invention is to accurately control a black out phenomenon.

In order to achieve the foregoing object, a black out correction device according to the present invention comprises a correction level storage for memorizing a signal level equal to an original signal level of a sampled signal outputted from an image sensing device when a black out is generated in a video created based on the sampled signal as a high-brightness clamping level, a comparator for comparing the signal level of sampled signal to a reference level for judging whether or not the black out is generated, and a selector for selecting and outputting the high-brightness clamping level when a result of the comparison by the comparator shows that the signal level falls below the reference level and selecting and outputting the sampled signal when the comparison result shows otherwise.

According to the foregoing black out correction device, when the comparator judges that the signal level of the sampled signal is below the reference level because the signal level of the sampled signal is so low that the black out phenomenon may be generated, the selector selects and outputs the high-brightness clamping level of the correction level storage, while the selector selects the sampled signal when the comparator judges the black out phenomenon is not generated because the signal level of the sampled signal is above the reference level.

As described, according to the present invention, the generation of the black out is detected, and the sampled signal is replaced with the high-brightness clamping level. Thereby, the black out phenomenon can be corrected without the reduction of a saturation level and sensitivity, which are generated when the black out is corrected in the image sensing device itself or peripheral circuits thereof. Further, the black out phenomenon can be detected and corrected by means of the digital method, which allows the processing to be executed at a high speed without any time delay.

The black out correction device constituted above preferably further comprises a reference level storage for memorizing the reference level and supplying the memorized reference level to the comparator, wherein the reference level memorized in the reference level storage can be variously set. As a result, flexible responses to a variation of a power-supply voltage or the like can be offered.

The black out correction device preferably further comprises a black level detector for detecting a signal level (black) corresponding to an optical black level of a video generated based on the sampled signal from the output of the selector, an integrator for calculating a black level integrated value by integrating the signal level (black) detected by the black level detector, an averager for calculating a black level average value by averaging the black level integrated value, and a subtracter for calculating the reference level by subtracting a predetermined value from the black level average value and supplying the calculated reference level to the comparator.

According to the black out correction device constituted above, the black level detector detects the signal level (black) of the sampled signal outputted from the selector, the integrator integrates the signal level (black), the averager calculates the average of the integration result, and the subtracter subtracts the predetermined value from the black level average value to thereby generate the reference level. Accordingly, the reference level is reliably set to be lower than the signal level (black), and further, the value of the reference level can be automatically compensated. As another advantage, the signal level (black) at the time is averaged, which attains a high accuracy in spite of the variation of the power-supply voltage or the like. As a result, flexible responses can be offered to deal with jitters generated in the reference level for judging whether or not the sampled signal causes the black out phenomenon due to the variation of the power-supply voltage or the like, and the black out phenomenon can be thereby accurately detected and corrected.

The black out correction device constituted above preferably further comprises a subtracted predetermined value storage for memorizing the predetermined value and supplying the memorized predetermined value to the subtracter, wherein the predetermined value memorized in the subtracted predetermined value storage can be variously set. As a result, the variation of the power-supply voltage or the like can be more flexibly dealt with.

The present invention can be applied to an image sensor as follows. An image sensor according to the present invention comprises an image sensing device, a pre-processor for sampling a signal outputted from the image sensing device, an A/D converter for digitally converting the sampled signal outputted from the pre-processor, and the black out correction device according to the present invention for correcting the black out in the output of the A/D converter. The image sensor preferably further comprises a clipping circuit for removing the signal level equal to or above the high-brightness clamping level from the output of the black out correction device.

When the clipping circuit is provided, the discontinuity of the signal levels by the switchover between the sampled signal and the high-brightness clamping level can be alleviated in the selector so that an image quality can be improved.

According to the present invention, when the black out level lower than the black level is detected from the sampled signal, the sampled signal is replaced with the high-brightness clamping level. Thereby, the black out phenomenon can be corrected without the reduction of the saturation level and sensitivity, which are generated when the black out is corrected in the image sensing device itself and the peripheral circuits thereof. Further, the black out phenomenon can be detected and corrected by means of the digital method, which allows the processing to be executed at a high speed without any time delay.

The black out correction device according to the present invention can be effectively installed in an image sensor in a mobile telephone provided with a photographing function, a digital still camera, an in-vehicle camera or the like.

### BRIEF DESCRIPTION OF THE DRAWINGS

These and other objects as well as advantages of the invention will become clear by the following description of preferred embodiments of the invention. A number of benefits not recited in this specification will come to the attention of the skilled in the art upon the implementation of the present invention.

FIG. 1 is a block diagram illustrating an entire constitution of an image sensor according to embodiments 1 and 2 of the present invention.

FIG. 2 is a block diagram illustrating a constitution of a black out correction device according to the embodiment 1.

FIG. 3 are illustrations of a factor that causes a black out phenomenon.

FIG. 4 are illustrations of an operation of the black out correction device according to the embodiment 1.

FIG. 5 is a block diagram illustrating a constitution of a black out correction device according to the embodiment 2.

FIG. 6 is an equivalent circuit diagram of a conventional MOS-type image sensing device.

FIG. 7 is a timing chart for describing an operation of the conventional MOS-type image sensing device (when normally operated).

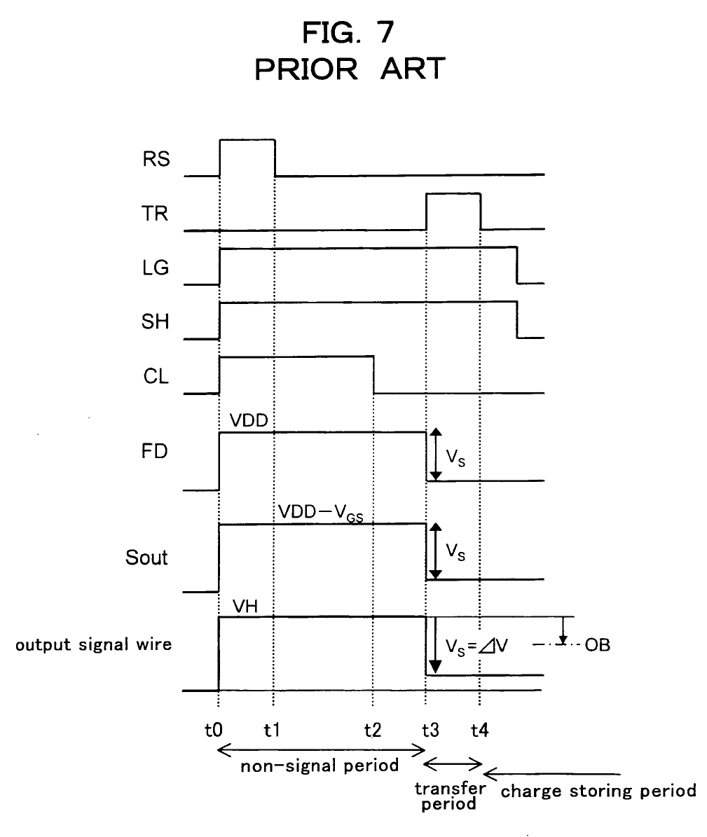

FIG. 8 is a timing chart for describing an operation of the conventional MOS-type image sensing device (when the black out is generated).

FIG. 9 are illustrations of the black out phenomenon.

FIG. 10 is a circuit diagram illustrating actions for preventing the black out (actions taken in a periphery of the sensor).

### DETAILED DESCRIPTION OF THE INVENTION

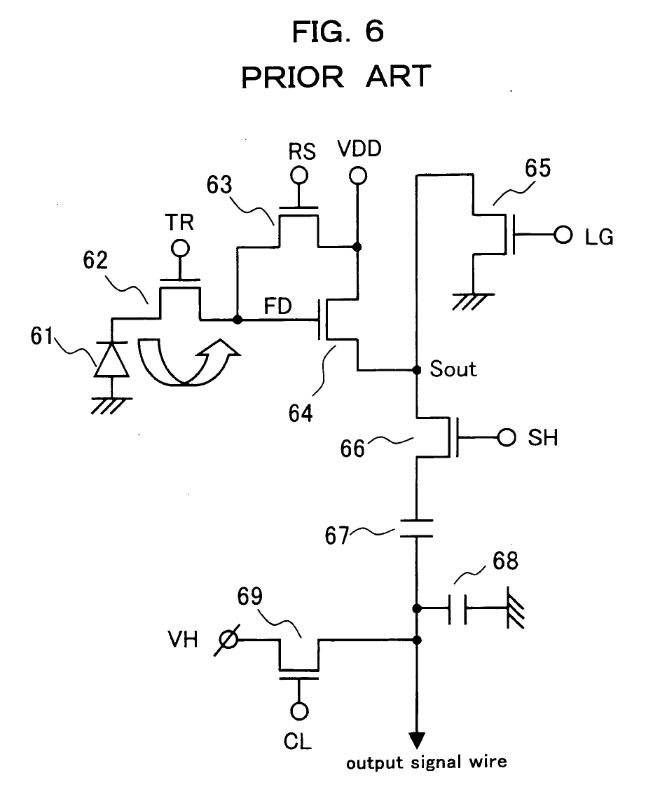

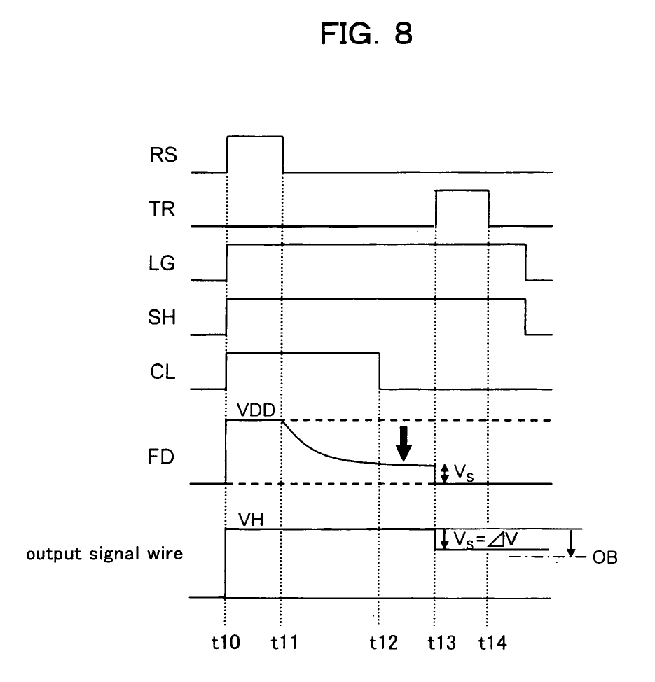

Before preferred embodiments of the present invention are described, an operation of an MOS-type image sensing device when a black out phenomenon is generated is described referring to FIG. 8. During a time period t10-t11, a voltage of a gate node FD of an output transistor 64 is reset by a reset pulse RS and initialized to a power-supply voltage VDD. When a large amount of lights enter a photodiode 61 at this stage, charges leak into the gate node FD from the photodiode 61 that received the large amount of incident lights at and after the time t11 when a reset transistor 63 is turned off though a read-out pulse TR is at “L” and a read-out transistor 62 is in an OFF state (see a curved arrow in FIG. 6). The leak is generated because there is a parasitic transistor between the photodiode 61 and the gate node FD. Due to the leak-in signal component, a potential of the gate node FD accidentally starts to fall. More specifically, a voltage of the gate node FD is below the initial level VDD in a read-out operation at a time t13. As a result, a signal component Vs is significantly reduced and results in a potential lower than a signal level (black) OB corresponding to an optical black level (a reference level is VH, and a downward direction of the signal level is positive).

As described, when the amount of incident lights with respect to the photodiode is significantly increased, an amplitude of the signal component is drastically reduced, and a part relevant to the reduction appears to be black on a screen, which is called the black out phenomenon. Hereinafter, the black out phenomenon is simply referred to as a black out. When an intensive light such as the sunlight enters, the black out is generated in a central part of the incident lights.

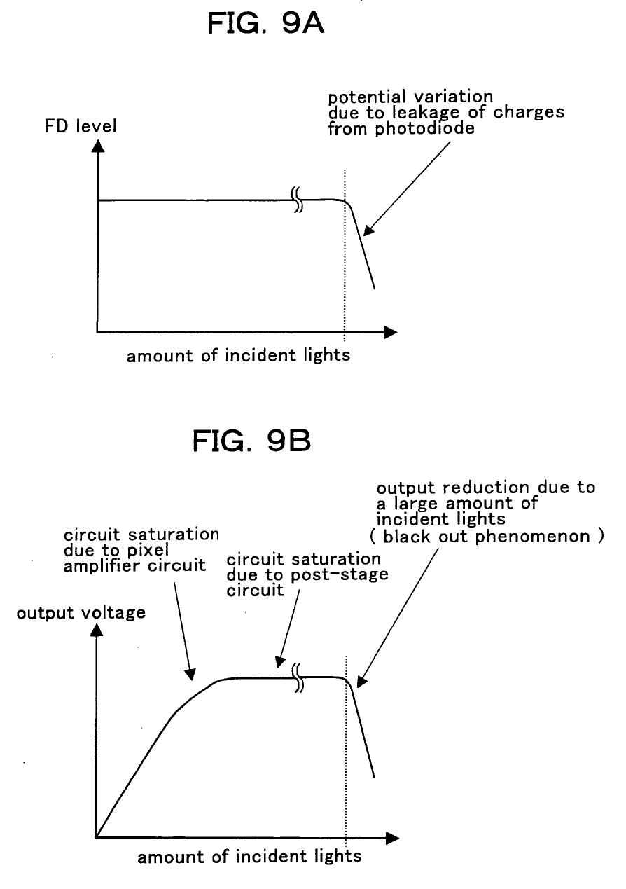

FIG. 9A shows a state where the potential of the gate node FD is drastically reduced when the amount of incident lights is significantly increased, while FIG. 9B shows a state where an amount of outputted signals is drastically reduced in response to the drastic reduction of the potential. First and second constitutions below were proposed in order to prevent the generation of the states shown in FIGS. 9A and 9B.

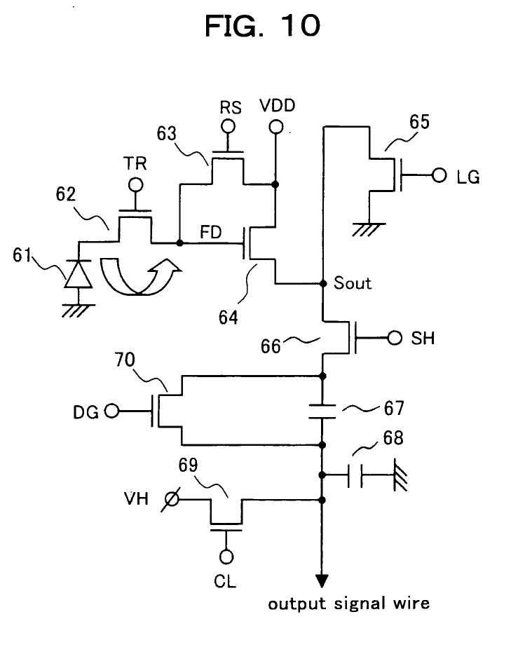

In the first constitution, a skip transistor 70 is connected in parallel to a clamping capacitor 67 as shown in FIG. 10. According to the first constitution, when a node Sout becomes lower than a certain voltage due to the leak-in charges in the case of the large amount of incident lights, the skip transistor 70 is turned so that the output is clipped.

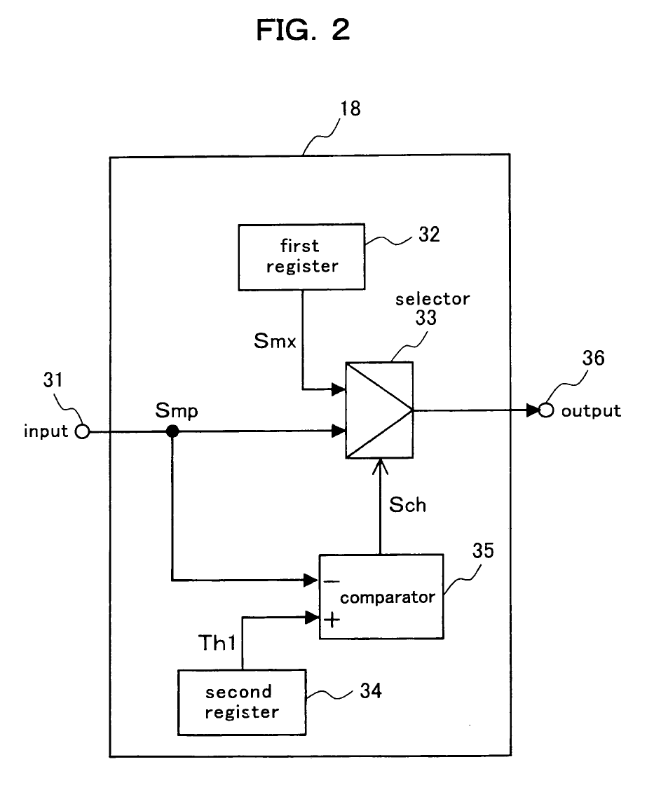

In the second constitution, an element for controlling the black out is provided in a pixel region as shown in Pages 5-6 and FIG. 2 of No. 2000-287131 of the Publication of the Unexamined Japanese Patent Applications. The second constitution comprises a sample and hold circuit and a comparator circuit, wherein the drop of a reset voltage is detected and any voltage lower than the reset voltage is replaced with a voltage Vr of a voltage generator and thereby processed.

In the first constitution, a saturation level decreases because the level of the photodiode is clipped. Further, an area of the photodiode is reduced in the case of providing the element for controlling the black out in the pixel region, which deteriorates the sensitivity of pixels.

In the second constitution wherein the analog process is adopted, jitters (variation in terms of time) are generated near a threshold for voltage detection, and a variation is thereby generated in the detected voltages. Further, when the voltage within a sampling time is slowly decreased, a time period for the replacement of the voltage is relatively short. As a result, the sampling in a subsequent stage cannot be processed.

Hereinafter, preferred embodiments of the present invention capable of controlling the black out so far described in detail are described referring to the drawings.

### Embodiment 1

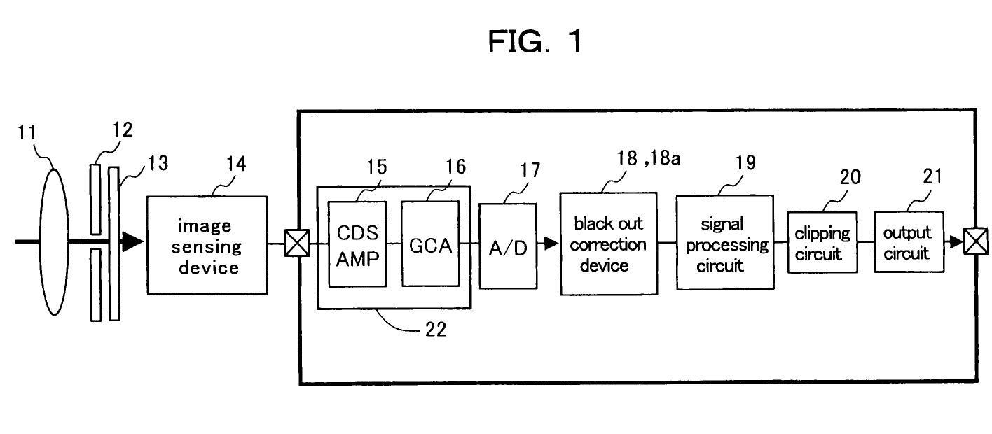

FIG. 1 is a block diagram illustrating an entire constitution of an image sensor according to an embodiment 1 of the present invention. The image sensor comprises a groups of lenses 11 for condensing lights, a diaphragm 12 for adjusting an amount of lights entering the group of lenses 11, a shutter 13 for mechanically blocking the light at a certain timing, an MOS-type image sensing device (for example, CMOS-type image sensing device) 14 for converting the incident light into an electrical signal, a CDS (Correlated Double Sampling) _AMP 15 for sampling the output of the image sensing device converted into the electrical signal, a GCA (Gain Control Amplifier) 16 for amplifying the sampled signal, an A/D converter 17 for converting the amplified analog signal into a digital signal, a black out correction device 18 for correcting the black out generated in the case of a large amount of incident lights, a signal processing circuit 19 for camera, a clipping circuit 20 for clipping a high-brightness signal, and an output circuit 21 for outputting a camera signal.

According to the present embodiment, the CDS_AMP 15 and the GCA 16 between the image sensing device 14 and the A/D converter 17 constitute a pre-processor 22.

FIG. 2 is a block diagram illustrating a detailed constitution of the black out correction device 18 according to the embodiment 1. The signal outputted from the image sensing device 14 and converted into the digital signal in the A/D converter 17 (hereinafter, referred to as a sampled signal Smp) is applied to an input terminal 31. The input terminal 31 is connected to an input terminal of a selector 33 and to an input terminal of a comparator 35.

A first register 32 is connected to another input terminal of the selector 33. The first register 32 is an example of a correction level storage for setting a high-brightness clamping level Smx having a value equal to or slightly higher than a high-brightness clamping level presumed to generate the black out (for example, a brightness level of a direct light from the sun).

A second register 34 is connected to another input terminal of the comparator 35. The second register 34 is an example of a reference level storage for setting a threshold level (reference level) Th1 lower than the signal level (black) OB corresponding to the optical black level. The comparator 35 compares a level of the sampled signal Smp inputted to the input terminal 31 to the threshold level Th1 set by the second register 34. Then, a switchover signal Sch supplied to the selector 33 is activated when the level of the sampled signal Smp is lower than the threshold level Th1 (Smp<Th1), while the switchover signal Sch supplied to the selector 33 is inactivated otherwise.

The selector 33 selects the high-brightness clamping level Smx supplied from the first register 32 when the switchover signal Sch is active, while selecting the sampled signal Smp supplied from the input terminal 31 when the switchover signal Sch is inactive. The selector 33 then outputs the selected signal to an output terminal 36.

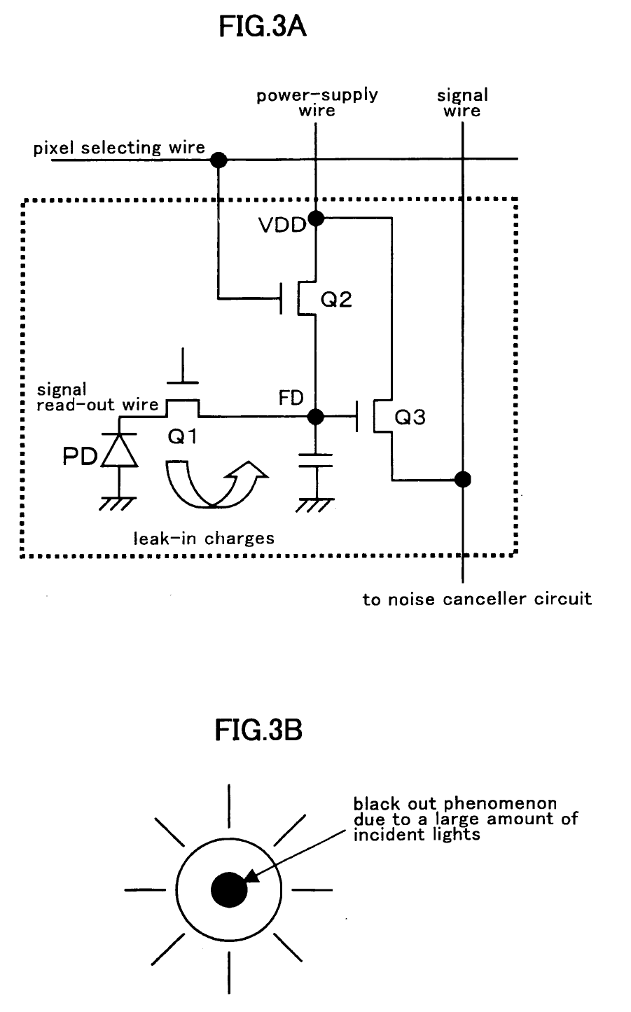

Next, an operation of the image sensor (MOS-type) according to the present embodiment thus constituted is described. First, an operation in the image sensing device 14 is described referring to FIG. 3A. An optical image of a photographic subject is inputted to the image sensing device 14 via the group of lenses 11, diaphragm 12 and shutter 13. It is assumed that a gate node FD of an output transistor Q3 is previously initialized to a reset voltage (VDD) in response to the conduction of a reset transistor Q2 in the image sensing device 14. The incident light with respect to the image sensing device 14 is of an ordinary level, there is no leakage of charges from a photodiode PD into the gate node FD during a period when a read-out transistor Q1 is turned off. However, when the sunlight is directly irradiated on the image sensor, thereby resulting in a large amount of incident lights equal to or higher than a threshold level of the read-out transistor Q1 into the photodiode PD, the charges leak into the gate node FD from the photodiode PD. The leak-in charges reduce a voltage of the gate node FD, thereby lowering the reference. As a result, an output level of the output transistor Q3 is significantly reduced, and the black out is thereby generated. As shown in FIG. 3B, the black out phenomenon is generated in a central part having a large amount of lights in an image having a high brightness (for example, an image of the sun). The black-out video signal, in the same manner as any other ordinary video signal, is sampled in the CDS_AMP 15 and inputted to the A/D converter 17 via the GCA 16. The inputted signal is then converted into a sampled signal (black out) Smp′ and inputted to the input terminal 31 of the black out correction device 18.

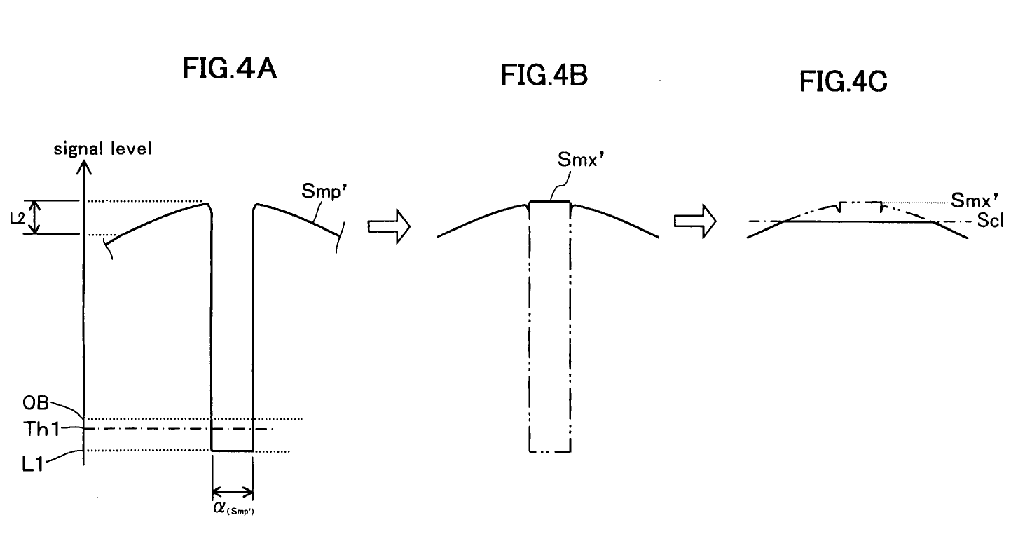

Of the sampled signals Smp inputted to the input terminal 31, in the sampled signal (black out) Smp′, a signal level L2 in a signal region other than a high-brightness central region (central region of the sunlight and the like) α_{(Smp′)} is higher than the signal level (black) OB as shown in FIG. 4A, though a signal level L1 in the high-brightness central region (central region of the sunlight and the like) is lower than the signal level (black) OB.

The sampled signal (black out) Smp′ thus characterized is inputted simultaneously to the selector 33 and the comparator 35. As described earlier, in the comparator 35, the threshold level Th1 is set to be slightly lower than the signal level (black) OB by the second register 34. The comparator 35 judges that the signal level L1 is lower than the threshold level Th1 (L1<Th1) in the high-brightness central region α_{(Smp′)} of the sampled signal (black out) Smp′, and activates the switchover signal Sch based on the judgment.

The selector 33 detects the active state of the switchover signal Sch and selects the high-brightness clamping level Smx set by the first register 32 and outputs it to the output terminal 36.

In contrast, the signal level L2 is higher than the signal level (black) OB in the region other than the high-brightness central region (central region of the sunlight and the like) α_{(Smp′)} in the sampled signal (black out) Smp′. Therefore, the comparator 35 judges that the signal level L2 in the region is equal to or higher than the threshold level Th1 (Th1≦L2). The comparator 35 having made the judgment inactivates the switchover signal Sch. The comparator 35 further inactivates the switchover signal Sch in an entire region of the normal sampled signals Smp undergoing no black out.

The selector 33 detects the inactive state of the switchover signal Sch and selects the sampled signal Smp supplied from the input terminal 41 and outputs it to the output terminal 36.

As a result of the correction process described so far, the high-brightness central region α_{(Smp′)} is selectively corrected in the sampled signal (black out) Smp′ as shown in FIG. 4B. The corrected sampled signal (black out) Smp′ is outputted to the signal processing circuit 19 shown in FIG. 19 from the output terminal 36 and subjected to various signal processes therein, and then, outputted to the clipping circuit 20.

The clipping circuit 20 retains therein a clipping level Sc1 lower than the high-brightness clamping level Smx set by the first register 32, and clips the high-brightness region of the sampled signal Smp using the clipping level Sc1 as shown in FIG. 4C, in other words, deletes the high-brightness region. Thereby, the discontinuity of the signal levels by the signal switchover in the high-brightness central region α_{(Smp′)} is cancelled so that an image quality can be improved. The clipped signal is outputted via the output circuit 21.

### Embodiment 2

In the embodiment 1, the threshold level Th1 memorized in the second register 34 has the fixed value. Therefore, when jitters are generated in the reference value for judging whether or not the sampled signal Smp causes the black out phenomenon (threshold level Th1 and the like) due to a variation of a power-supply voltage or the like, the black out phenomenon may not be detected and corrected as accurately as desired. An embodiment 2 of the present invention solves the disadvantage.

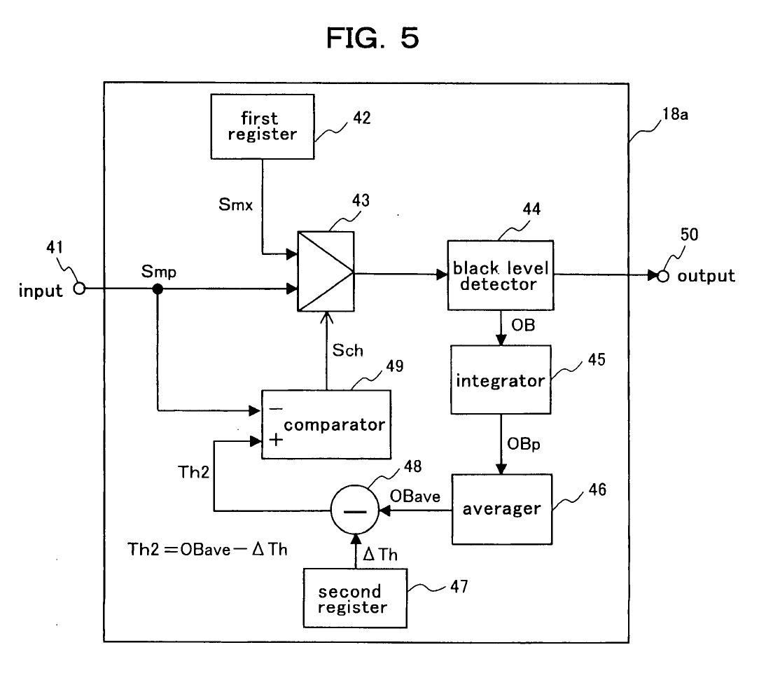

An image sensor according to embodiment 2 is described below. FIG. 1 is also applied to the embodiment 2 . FIG. 5 is a block diagram illustrating a detailed constitution of a black out correction device 18a according to the embodiment 2. The signal outputted from the image sensing device 14 and converted into the digital signal by the A/D converter 17 is applied to the input terminal 41. The input terminal 41 is connected to an input terminal of a selector 43 and an input terminal of a comparator 49. A first register 42 is connected to another input terminal of the selector 43. The first register 42 is an example of the correction level storage for setting the high-brightness clamping level Smx slightly higher than the high-brightness clamping level (for example, brightness level of the direct light from the sun) presumed to generate the black out.

The black out correction device 18a according to the embodiment 2 comprises, in addition to the components described in the embodiment 1, comprises a black level detector 44 for detecting the signal level (black) OB corresponding to the optical black level of the video from the signal outputted from the selector 43, an integrator 45 for integrating the signal level (black) OB detected by the black level detector 44, an averager 46 for calculating a black level average value OBₐᵥₑ by averaging a black level integrated value OBₚ integrated by the integrator 45, and a subtracter 48 for generating and outputting a threshold level Th2 by subtracting a predetermined value ΔTh from the black level average value OBₐᵥₑ. The predetermined value ΔTh is constantly smaller than a black level average value OBₐᵥₑ, or is set based on OBₐᵥₑ−ΔTh>0 (to improve the accuracy for OB variation).

The predetermined value ΔTh used in the subtracter 48 is memorized in a second register 47. The second register 47 is an example of a subtracted predetermined value storage. The threshold level Th2 calculated as a result of the subtraction in the subtracter 48 is inevitably maintained at a level lower than the black level average value OBₐᵥₑ at all time.

The threshold level Th2 calculated by the subtracter 48 is supplied to a non-inversion input terminal (+) of the comparator 49. The comparator 49 compares the sampled signal Smp inputted to the input terminal 41 and the threshold level Th2 supplied from the subtracter 48. Then, the switchover signal Sch supplied to the selector 33 is activated when the level of the sampled signal Smp is lower than the threshold level Th2 (Smp<Th2), while the switchover signal Sch supplied to the selector 33 is inactivated otherwise.

The selector 33 selects the high-brightness clamping level Smx supplied from the first register 32 when the switchover signal Sch is active, while selecting the sampled signal Smp supplied from the input terminal 31 when the switchover signal Sch is inactive. Then, the selected signal is outputted to the output terminal 36.

The black out correction processed by the image sensor according to the present embodiment thus constituted is basically processed in the same manner as described in the embodiment 1, except for the setting of the threshold level Th2.

The sampled signal Smp outputted from the selector 43 is inputted to the signal processing circuit 19 provided behind an output terminal 50. At the time, the black level detector 44 detects the signal level (black) OB in the sampled signal Smp and supplies the detected signal level to the integrator 45. The integrator 45 integrates the signal level (black) OB per sampling period to thereby calculate the black level integrated value OBₚ. The integrator 45 supplies the calculated black level integrated value OBₚ to the averager 46. The averager 46 divides the black level integrated value OBₚ by the number of the samplings to thereby calculate the black level average value OBₐᵥₑ and supplies it to the subtracter 48. The subtracter 48 subtracts the predetermined value ΔTh supplied from the second register 47 from the black level average value OBₐᵥₑ supplied from the averager 46 to thereby calculate the threshold level Th2. The subtracter 48 supplies the calculated threshold level Th2 to the non-inversion input terminal (+) of the comparator 49.

The threshold level Th2 serves as the reference level for judging whether or not the sampled signal Smp causes the black out phenomenon in the same manner as the threshold level Th1. However, the threshold level Th2 is constantly renewed through the subtraction of the predetermined value ΔTh from the black level average value OBₐᵥₑ in the subtracter 48.

As thus far described, according to the present embodiment, the signal level (black) OB is detected, the black level average value OBₐᵥₑ is calculated, and the level lower than the black level average value OBₐᵥₑ by the predetermined value ΔTh is used as the threshold level Th2 of the comparator 49. Further, the value of the threshold level Th2 is constantly renewed. As a result, the black out phenomenon can be detected and corrected with a high accuracy when the jitters are generated in the reference level for judging whether or not the sampled signal Smp causes the black out phenomenon due to the variation of the power-supply voltage or the like. Further, the black out phenomenon is digitally detected and corrected, which increases the speed of the processing causing no time delay. Then, the variation of the power-supply voltage or the like can be flexibly and speedily dealt with.

In the respective embodiments described so far, the brightness clamping level is set to the signal level slightly higher than the signal level when the black out is generated, which is merely an example. Any other signal level can be adopted as far as it is such a level that the black out can be corrected. Further, in the respective embodiments, the reference level is set to the signal level corresponding to the brightness level slightly lower than the black level in the brightness levels, which is merely an example. Any other signal level can be adopted as far as it is such a level that the black out can be detected.

While there has been described what is at present considered to be preferred embodiments of this invention, it will be understood that various modifications may be made therein, and it is intended to cover in the appended claims all such modifications as fall within the true spirit and scope of this invention.

What is claimed is:

1. A black out correction device comprising:
a correction level storage for memorizing a signal level equal to an original signal level of a sampled signal outputted from an image sensing device when a black out is generated in a video created based on the sampled signal as a high-brightness clamping level;
a comparator for comparing the signal level of sampled signal to a reference level for judging whether or not the black out is generated; and
a selector for selecting and outputting the high-brightness clamping level when a result of the comparison by the comparator shows that the signal level falls below the reference level and selecting and outputting the sampled signal when the comparison result shows otherwise.

2. A black out correction device as claimed in claim 1, wherein the image sensing device is an MOS-type image sensing device.

3. A black out correction device as claimed in claim 1, wherein the high-brightness clamping level is set to a signal level slightly higher than the signal level when the black out is generated.

4. A black out correction device as claimed in claim 1, wherein the reference level is set to a signal level corresponding to a brightness level slightly lower than a black level in brightness levels.

5. A black out correction device as claimed in claim 1, further comprising a reference level storage for memorizing the reference level and supplying the memorized reference level to the comparator.

6. A black out correction device as claimed in claim 1, further comprising:
a black level detector for detecting a signal level (black) corresponding to an optical black level of a video generated based on the sampled signal from an output of the selector;
an integrator for calculating a black level integrated value by integrating the signal level (black) detected by the black level detector;
an averager for calculating a black level average value by averaging the black level integrated value; and
a subtracter for calculating the reference level by subtracting a predetermined value from the black level average value and supplying the calculated reference level to the comparator.

7. A black out correction device as claimed in claim 3, further comprising a subtracted predetermined value storage for memorizing the predetermined value and supplying the memorized predetermined value to the subtracter.

8. An image sensor comprising:
an image sensing device;
a pre-processor for sampling a signal outputted from the image sensing device;
an A/D converter for digitally converting the sampled signal outputted from the pre-processor; and
the black out correction device for correcting the black out in an output of the A/D converter as claimed in claim 1.

9. An image sensor as claimed in claim 8, further comprising a clipping circuit for removing a signal level equal to or above the high-brightness clamping level from an output of the black out correction device.
